(19) United States
(12) Patent Application Publication
(10) Pub. No.: US 2006/0140573 A1
(43) Pub. Date: Jun. 29, 2006

(54) Apparatus for detecting output power in dual-mode portable wireless terminal

(75) Inventor: Min-Seok Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/297,180

(22) Filed: Dec. 8, 2005

(30) Foreign Application Priority Data
Dec. 24, 2004 (KR) 2004-0112161

(51) Int. Cl. G02B 6/00

(52) U.S. Cl. 385/147

(57) ABSTRACT

Disclosed is an apparatus for detecting an output power in a dual-mode portable wireless terminal. The apparatus includes a first coupler for coupling a signal that passes through a first transmission signal path; a second coupler for coupling a signal that passes through a second transmission signal path; a power combiner for combining coupled signals that are respectively output from the first coupler and the second coupler; and a power detector for outputting a DC voltage based on a power level of an output signal of the power combiner. When a power detection circuit chip having one input port is used, the power detection for two transmission paths can be achieved using one chip. Thus, the circuit size can be remarkably reduced.

### PRIORITY

This application claims priority under 35 U.S.C. § 119 to an application entitled “APPARATUS FOR DETECTING OUTPUT POWER IN DUAL-MODE PORTABLE WIRELESS TERMINAL” filed in the Korean Intellectual Property Office on Dec. 24, 2004 and assigned Serial No. 2004-112161 the contents of which are incorporated herein by reference.

### BACKGROUND OF THE INVENTION

1. Field of the Invention

The present invention relates to an RF front-end unit in a portable wireless terminal, and more particularly, to an apparatus for detecting an output power in a dual-mode portable wireless terminal.

2. Background of the Prior Art

A dual-mode terminal receives different frequency bands. Such a dual-mode terminal includes a terminal supporting Advanced Mobile Phone Service (AMPS) and Code Division Multiple Access (CDMA), a terminal supporting Global System for Mobile Communications (GSM) and CDMA, and a terminal supporting Wideband CDMA and CDMA2000 1x.

A dual-mode (or dual-band) terminal (hereinafter, referred to as a CDMA/AMPS terminal) supporting 800-MHz CDMA and 1900-MHz AMPS will now be described as one example.

In the CDMA/AMPS terminal, a power detection circuit is provided on a transmission signal path or a reception signal path for various purposes. For example, the power detection circuit detects an output power of a power amplifier and controls a gain of an Auto Gain Controller (AGC).

FIG. 1 is a block diagram of an RF front-end unit in a conventional CDMA/AMPS terminal.

In a CDMA path, a first power amplifier 101 amplifies a power of an input signal. A first coupler 102 is a directional coupler that couples part of an output signal of the first power amplifier 101 and outputs the coupled signal to a power detector 106. A first isolator 103 functions to protect a termination circuit of the first power amplifier 101. For example, the first isolator 103 terminates a signal that is reflected backward when there occurs a malfunction in an antenna feed line. A first duplexer 104 passes only a CDMA transmission frequency signal among the output signals of the first isolator 103. A diplexer 105 is a filter that passes different frequency signals. The diplexer 105 passes the frequency signal output from the first duplexer 104 and provides it to an antenna.

In an AMPS path, a second power amplifier 111 amplifies a power of an input signal. A second coupler 112 is a directional coupler that couples part of an output signal of the second power amplifier 111 and outputs the coupled signal to power detector 106. A second isolator 113 transfers an output of the second power amplifier 111 to a second duplexer 114 according to directionality shown in FIG. 1 and terminates an output signal of the second duplexer 114. The second duplexer 114 passes only an AMPS transmission frequency signal among the output signals of the second isolator 113. The diplexer 105 passes the frequency signal output from the second duplexer 114 and provides it to the antenna.

The power detector 106 combines the coupled signals output from the first coupler 102 and the second coupler 112 and detects the combined signal by using diodes. Then, the power detector 106 outputs a DC(Direct Current) voltage based on an RF signal level to a modem controller 107. Since only one of the CDMA path and the AMPS path is activated, the DC voltage from the power detector 106 represents a power that is detected from the current activated path. The modem controller 107 determines an output power level of the power amplifier according to the DC voltage output from the power detector 106, and controls an operation of the components according to the determined output power level. For example, the modem controller 107 controls a transmission power by controlling a gain of the AGC.

As described above, the power detector 106 is configured with diodes. However, it is difficult for the diodes to correctly detect the power due to temperature variation. Thus, a problem occurs in that power control performance is degraded. Alternatively, power detectors (chips) may be configured with linear OP amplifiers that have wide input range. In this case, since such a chip has one input port, and the conventional dual-mode portable wireless terminal requires as many chips as coupled signals, there is a resulting increase in the circuit size. Accordingly, there is a demand for a method that can efficiently combine the coupled signal when a power detector having one input port is used in a dual-mode portable wireless terminal.

### SUMMARY OF THE INVENTION

The present invention provides an apparatus for detecting power for two signal paths using one circuit chip in a portable wireless terminal.

Also, the present invention provides an apparatus for effectively combining powers of signals coupled on two transmission signal paths in a dual-mode portable wireless terminal.

Further, the present invention provides an apparatus for detecting an output power by combining output powers of two power amplifiers in a dual-mode portable wireless terminal.

Further, the present invention provides an apparatus for detecting an output power in a dual-mode portable wireless terminal.

Further, the present invention provides an apparatus for detecting an output power through a power detection circuit chip having one input port by combining signals coupled on two transmission paths in a dual-mode portable wireless terminal.

According to an aspect of the present invention, an apparatus for detecting an output power in a dual-mode portable wireless terminal includes a first coupler for coupling a signal that passes through a first transmission signal path; a second coupler for coupling a signal that passes through a second transmission signal path; a power combiner for combining coupled signals that are respectively output from the first coupler and the second coupler; and a power detector for outputting a DC voltage based on a power level of an output signal of the power combiner.

According to another aspect of the present invention, an apparatus for detecting an output power in a dual-mode portable wireless terminal includes a first coupler for coupling an output signal of a first power amplifier corresponding to a first communication mode; a second coupler for coupling an output signal of a second power amplifier corresponding to a second communication mode; a diplexer for combining coupled signals that are respectively output from the first coupler and the second coupler; and a power detector for outputting a DC voltage based on a power level of an output signal of the diplexer.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a conventional RF front-end unit in a CDMA/AMPS terminal;

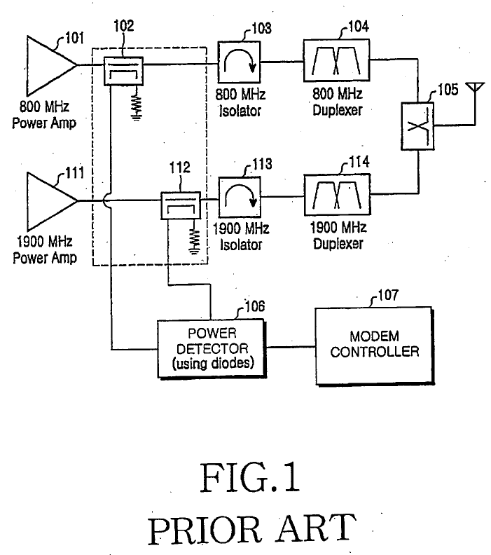

FIG. 2 is a block diagram of an RF front-end unit in a dual-mode portable wireless terminal according to a first embodiment of the present invention;

FIG. 3 is a block diagram of an RF front-end unit in a dual-mode portable wireless terminal according to a second embodiment of the present invention;

FIG. 4 is a block diagram of an RF front-end unit in a dual-mode portable wireless terminal according to a third embodiment of the present invention;

FIG. 5 is a block diagram of an RF front-end unit in a dual-mode portable wireless terminal according to a fourth embodiment of the present invention; and

FIG. 6 is a block diagram of an RF front-end unit in a dual-mode portable wireless terminal according to a fifth embodiment of the present invention.

### DETAILED DESCRIPTION OF THE PREFERRED EMBODIMENTS

Reference will now be made in detail to preferred embodiments of the present invention, examples of which are illustrated in the accompanying drawings. A detail description of well-known features will be omitted for conciseness.

The present invention provides an apparatus for detecting a power in a dual-mode (or dual-band) portable wireless terminal that receives different frequency bands. The apparatus combines signals coupled on two transmission paths. According to this combining method, powers of two transmission signal paths are detected using one power detection circuit chip, resulting in reduction in the circuit size. There are various kinds of dual-mode portable wireless terminals. In the embodiments of the present invention, a CDMA/AMPS terminal will be described as one example.

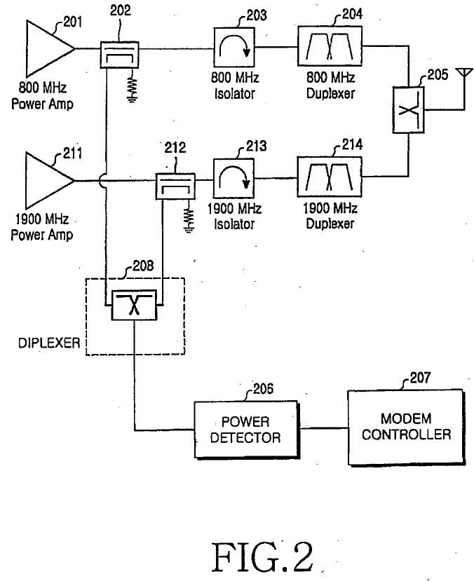

FIG. 2 is a block diagram of an RF front-end unit in a dual-mode portable wireless terminal according to a first embodiment of the present invention. In FIG. 2, directional couplers 202 and 212 are used and the coupled signals are combined using a diplexer 208.

In a CDMA path, a first power amplifier 201 amplifies a power of an input transmission signal. First coupler 202 is a directional coupler that couples part of an output signal of the first power amplifier 201 and outputs the coupled signal to diplexer 208. A first isolator 203 transfers the output signal of the first power amplifier 201 to a first duplexer 204 according to directionality shown in FIG. 2 and terminates a signal that is reflected backward from the first duplexer 204. That is, the first isolator 203 functions to protect a termination circuit of the first power amplifier 201. The first duplexer 204 passes only a CDMA transmission frequency signal among the output signals of the first isolator 203. The diplexer 205 is a filter that passes different frequency signals. The diplexer 205 passes the frequency signal output from the first duplexer 204 and provides it to an antenna.

In an AMPS path, a second power amplifier 211 amplifies a power of an input transmission signal. A second coupler 212 is a directional coupler that partially couples an output signal of the second power amplifier 211 and outputs the coupled signal to the diplexer 208. A second isolator 213 transfers an output of the second power amplifier 211 to a second duplexer 214 according to directionality shown in FIG. 2 and terminates an output signal of the second duplexer 214. The second duplexer 214 passes only an AMPS transmission frequency signal among the output signals of the second isolator 213. The diplexer 205 passes the frequency signal output from the second duplexer 214 and provides it to the antenna.

The diplexer 208 serves as a filter that passes different frequency signals and combines powers of the coupled signals that are respectively output from the first coupler 202 and the second coupler 212. In this manner, the diplexer 208 transfers the coupled signals to the power detector 206 without any additional control signal. The power detector 206 outputs a DC voltage based on a power level of the output signal of the diplexer 208 to a modem controller 207. The power detector 206 may use an Analog Device (AD) 8362 chip.

Since a selected one of the CDMA path and the AMPS path is activated, the DC voltage from the power detector 206 represents a power detected from the current activated path. The modem controller 207 determines an output power level of the power amplifier (or the terminal) according to the DC voltage output from the power detector 206, and controls an operation of the components according to the determined output power level. For example, the modem controller 207 controls a transmission power by controlling a gain of the AGC.

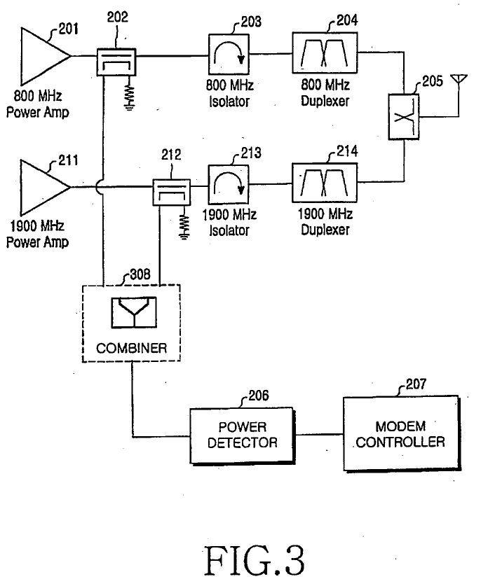

FIG. 3 is a block diagram of an RF front-end unit in a dual-mode portable wireless terminal according to a second embodiment of the present invention. In this embodiment, directional couplers 202 and 212 are used and the coupled signals are combined using a combiner 308. In FIG. 3, the same reference numerals are used to refer to the same elements as those of FIG. 2, and a detailed description thereof will be omitted.

Referring to FIG. 3, a first coupler 202 is a directional coupler that couples part of an output signal of a first power amplifier 201 and outputs the coupled signal to a combiner 308. A second coupler 212 is a directional coupler that couples part of an output signal of a second power amplifier 211 and outputs the coupled signal to the combiner 308. The combiner 308 combines powers of the coupled signals that are respectively output from the first coupler 202 and the second coupler 212. The combiner 308 is preferably a broadband combiner that receives signals having different frequency bands.

The power detector 206 outputs a DC voltage based on a power level of the output signal of the combiner 308 to a modem controller 207. The power detector 206 may use an Analog Device (AD) 8362 chip. The modem controller 207 determines an output power level of the power amplifier (or the terminal) according to the DC voltage output from the power detector 206, and controls an operation of the components (e.g., AGC) according to the determined output power level.

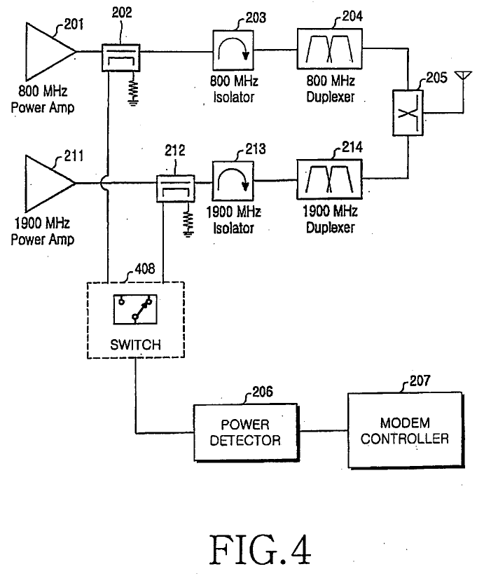

FIG. 4 is a block diagram of an RF front-end unit in a dual-mode portable wireless terminal according to a third embodiment of the present invention. In this embodiment, directional couplers 202 and 212 are used and the coupled signals are combined using an RF switch 408. In FIG. 4, the same reference numerals are used to refer to the same elements as those of FIG. 2, and a detailed description thereof will be omitted.

Referring to FIG. 4, a first coupler 202 is a directional coupler that couples part of an output signal of a first power amplifier 201 and outputs the coupled signal to an RF switch 408. A second coupler 212 is a directional coupler that couples part of an output signal of a second power amplifier 211 and outputs the coupled signal to the RF switch 408. The RF switch 408 is preferably a Single Pole Dual Through (SPDT) switch. When a CDMA path is activated, the RF switch 408 switches to connect an output signal of the first coupler 202 to a power detector 206 in response to a control signal (not shown) output from a modem controller 207. On the contrary, when an AMPS path is activated, the RF switch 408 switches to connect an output signal of the second coupler 212 to the power detector 206 in response to the control signal.

The power detector 206 outputs a DC voltage based on a power level of the output signal of the RF switch 408 to a modem controller 207. The modem controller 207 determines an output power level of the power amplifier (or the terminal) according to the DC voltage output from the power detector 206, and controls an operation of the components according to the determined output power level.

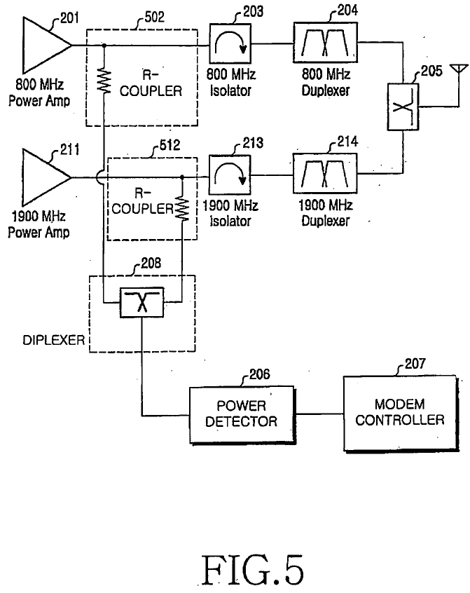

FIG. 5 is a block diagram of an RF front-end unit in a dual-mode portable wireless terminal according to a fourth embodiment of the present invention. In this embodiment, R-couplers 502 and 512 (couplers using resistors) are used and the coupled signals are combined using a diplexer 208. In FIG. 5, the same reference numerals are used to refer to the same elements as those of FIG. 2, and a detailed description thereof will be omitted.

Referring to FIG. 5, a first R-coupler 502 couples part of an output signal of a first power amplifier 201 and outputs the coupled signal to a diplexer 208. A second R-coupler 512 couples part of an output signal of a second power amplifier 211 and outputs the coupled signal to the diplexer 208. The diplexer 208 is a filter that passes different frequency signals. The diplexer 208 combines powers of the coupled signals that are respectively output from the first R-coupler 502 and the second R-coupler 512. The diplexer 208 transfers the coupled signals to a power detector 206 without any additional control signal. The power detector 206 outputs a DC voltage based on a power level of the output signal of the diplexer 208 to a modem controller 207. The modem controller 207 determines an output power level of the power amplifier (or the terminal) according to the DC voltage outputted from the power detector 206, and controls an operation of the components (e.g., AGC) according to the determined output power level.

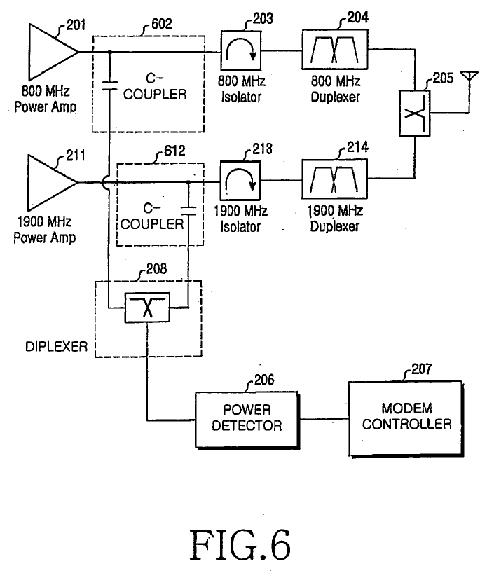

FIG. 6 is a block diagram of an RF front-end unit in a dual-mode portable wireless terminal according to a fifth embodiment of the present invention. In this embodiment, C-couplers 602 and 612 (couplers using capacitors) are used and the coupled signals are combined using a diplexer 208. In FIG. 6, the same reference numerals are used to refer to the same elements as those of FIG. 2, and a detailed description thereof will be omitted.

Referring to FIG. 6, a first C-coupler 602 couples part of an output signal of a first power amplifier 201 and outputs the coupled signal to a diplexer 208. A second C-coupler 612 couples part of an output signal of a second power amplifier 211 and outputs the coupled signal to the diplexer 208.

The diplexer 208 combines powers of the coupled signals that are respectively output from the first C-coupler 602 and the second C-coupler 612. The power detector 206 outputs a DC voltage based on a power level of the output signal of the diplexer 208 to a modem controller 207. The modem controller 207 determines an output power level of the power amplifier (or the terminal) according to the DC voltage outputted from the power detector 206, and controls an operation of the components (e.g., AGC) according to the determined output power level.

As described above, the embodiments of the present invention provide three couplers, that is, the directional coupler, the R-coupler and the C-coupler. It is preferable that the couplers are selected according to characteristics of the circuits. For example, the directional coupler can be used in a system that emphasizes performance, and the R-coupler or the C-coupler can be used in a system that requires low cost. Also, the embodiments of the present invention provide three power combiners, that is, the diplexer, the combiner and the RF switch. The use of the diplexer is preferable in view of cost and simplicity in implementation.

Although a CDMA/AMPS terminal has been described above, the present invention can also be applied to other dual-mode (or dual-band) terminals. In addition, it is apparent to those skilled in the art that a combination of the R-coupler and the combiner, a combination of the R-coupler and the RF switch, a combination of the C-coupler and the combiner, and a combination of the C-coupler and the RF switch can also be used.

According to the present invention, when the power detection circuit chip having one input port is used in the dual-mode portable wireless terminal, the power detection for two transmission paths can be achieved using one chip. Thus, the circuit size can be remarkably reduced. Also, the present invention can be applied to any coupling structure and is advantageous in view of cost and size.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for detecting an output power in a dual-mode portable wireless terminal, the apparatus comprising:
a first coupler for coupling a signal that passes through a first transmission signal path;
a second coupler for coupling a signal that passes through a second transmission signal path;
a power combiner for combining coupled signals output from the first coupler and the second coupler; and
a power detector for outputting a DC voltage based on a power level of an output signal of the power combiner.

2. The apparatus of claim 1, wherein the first and second couplers are one of a directional coupler, an R-coupler and a C-coupler.

3. The apparatus of claim 1, wherein the power combiner is a diplexer.

4. The apparatus of claim 1, wherein the power combiner is a combiner.

5. The apparatus of claim 1, wherein the power combiner is an SPDT (Single Pole Dual Through) switch.

6. The apparatus of claim 1, wherein the first and second couplers are respectively connected to output terminals of power amplifiers positioned on the corresponding transmission signal paths.

7. The apparatus of claim 1, further comprising a modem controller for determining an output power level of the terminal according to the DC voltage and controlling a transmission power of the terminal according to the determined power level.

8. The apparatus of claim 1, wherein the first transmission signal path is a path for CDMA (Code Division Multiple Access) communication, and the second transmission signal path is a path for AMPS (Advanced Mobile Phone Service) communication.

9. An apparatus for detecting an output power in a dual-mode portable wireless terminal, the apparatus comprising:
a first coupler for coupling an output signal of a first power amplifier corresponding to a first communication mode;
a second coupler for coupling an output signal of a second power amplifier corresponding to a second communication mode;
a diplexer for combining coupled signals output from the first coupler and the second coupler; and
a power detector for outputting a DC voltage based on a power level of an output signal of the diplexer.

10. The apparatus of claim 9, wherein the first and second couplers are one of a directional coupler, an R-coupler and a C-coupler.

11. The apparatus of claim 9, wherein the first communication mode is a CDMA (Code Division Multiple Access) mode, and the second communication mode is an AMPS (Advanced Mobile Phone Service) mode.

12. The apparatus of claim 9, further comprising a modem controller for determining an output power level of the terminal according to the DC voltage and controlling a transmission power of the terminal according to the determined power level.
